(19) United States
(12) Patent Application Publication
(10) Pub. No.: US 2010/0086659 A1
(43) Pub. Date: Apr. 8, 2010

(54) METHOD AND APPARATUS FOR MANUFACTURING A FOOD PRODUCT

(75) Inventor: Siegfried Schmidt, Verden (DE)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 12/531,805

(22) PCT Filed: Apr. 24, 2008
(86) PCT No.: PCT/EP08/03293

§ 371 Date: Oct. 7, 2009

(30) Foreign Application Priority Data
Apr. 26, 2007 (DE) 10 2007 019 696.4

(51) Int. Cl. A23L 3/40; A23L 1/30; A23L 1/311; A23L 3/18

(52) U.S. Cl. 426/471; 99/467; 99/483; 99/507

(57) ABSTRACT

A method of manufacturing a food product that includes the steps of: delivering a protein and water-containing carrier material to a turboreactor which has a cylindrical reaction chamber with a substantially horizontal longitudinal axis and with a rotor equipped with blades and rotatable about its longitudinal axis provided in the reaction chamber. The rotor is rotated at a speed sufficient to centrifuge the carrier material against an inner wall of the reaction chamber and to form a dynamic, turbulent layer at the inner wall. The carrier material is heat treated and dried in the reaction chamber and is then advanced in the direction of an outlet from the turboreactor. The heat-treated and dried carrier material as a food product is withdrawn from the outlet, wherein an atmosphere of superheated steam is generated in the reaction chamber.

### CROSS-REFERENCE TO RELATED APPLICATIONS

This Application is a national stage application of PCT/EP2008/003293 filed Apr. 24, 2008 and claiming priority to DE 10 2007 019 696.4 filed on Apr. 26, 2007.

### TECHNICAL FIELD

The invention relates to a method and an apparatus for manufacturing a food product, in which a matrix of a starting or carrier material containing water and optionally proteins is prepared and can be provided with a probiotic substance as an additive, of the kind that is known from EP 0 862 863, for example. The known method provides for the carrier material to form a matrix of gelatinized starch and to be coated or filled with a probiotic material.

### BRIEF SUMMARY OF THE INVENTION

The object of the present invention is to provide a novel and improved method of manufacturing a food product, which leads to food products that contain fewer germs and have longer shelf lives than hitherto, and an apparatus for carrying out the method.

This object is achieved in accordance with the invention by a method of manufacturing a food product comprising the following steps:
a) delivering a water-containing carrier material to a turboreactor which has a cylindrical reaction chamber with a substantially horizontal longitudinal axis and with a rotor equipped with blades and rotatable about its longitudinal axis provided in the reaction chamber,
b) rotating the rotor at a speed sufficient to centrifuge the carrier material against an inner wall of said reaction chamber and to form a dynamic, turbulent layer at the inner wall,
c) heat-treating and drying the carrier material in the reaction chamber,
d) advancing the carrier material in the direction of an outlet from the turboreactor and withdrawing the heat-treated and dried carrier material as food product from the outlet,

the method being characterized by the fact that an atmosphere of superheated steam with an oxygen content of less than 10% by volume is generated in the reaction chamber.

Individual food products can be formed from the food product.

It can be contemplated that the food product or the heat-treated and dried carrier material is provided with a prebiotic substance and/or probiotic micro-organisms. In this context, it can be provided that the heat-treated carrier material is sprayed or coated with a prebiotic substance and/or with probiotic micro-organisms.

The carrier material can be mixed or coated with the probiotic micro-organisms in an encapsulated form.

It is preferable for the carrier material to be protein-containing and to be manufactured from meat (beef, pork, poultry, or any other origin), fish and/or protein produced biologically or by micro-organisms. In order to ensure that the carrier material is suitable for pumping, fibers or particles present in the carrier material may be comminuted, before delivery to the reaction chamber, to a size necessary or suitable for this purpose, especially to a length of less than 5 mm, and preferably less than 3 mm.

It is appropriate for the inner wall of the turboreactor to be heated to a temperature in the range from 50° C. to 150° C., and it may further be provided that the inner wall of the turboreactor is heated up in sections to different temperatures, such as with temperatures rising or falling in a longitudinal direction. As a result of the heat treatment, the carrier material can be micro-biologically stabilized. In addition, the carrier material may be treated enzymatically, e.g. pre-digested, before the heat treatment.

The heat treatment of the carrier material can be carried out for an average dwell time of 1 to 10 minutes, preferably 2 to 5 minutes and even more preferably about 3 minutes. The rotor may be rotated at a speed between 200 and 2,000 revolutions per minute, preferably between 300 and 1,500 revolutions per minute and even more preferably between 500 and 1,000 revolutions per minute, the speed preferably being set such that a peripheral speed at the blade tips of about 10 to 12 m/s is achieved. The method may preferably be carried out continuously, i.e. with a constant stream of carrier material being introduced into the turboreactor and a likewise continuous mass flow being withdrawn from the outlet. The turbulent layer referred to may first of all be a fluid layer or a layer formed from soft, plastic particles.

During the heat treatment of the carrier material, an inert gas, such as CO₂ or N₂, may be introduced into or passed through the reaction chamber in addition. It can be provided that the carrier material is dried to a total water content of less than 50%, especially less than 40%. Furthermore, it can be provided that the carrier material is further dried after leaving the turboreactor in a turboreactor downstream. The carrier material can be dried to a total water content of less than 20%, especially less than 10%. The dried carrier material may have an AW value of less than 0.6, especially less than 0.15.

The invention further provides for the heat-treated and dried carrier material to be cooled.

In a further embodiment of the invention, it can be contemplated that the (heat-treated and optionally dried and cooled) carrier material may be additionally mixed with a binder which is preferably free of gelatinized starch and in particular is free of starch.

It is further envisaged that minerals, vitamins and/or trace elements may be added to the heat-treated carrier material after the heat treatment. In addition, chunky additives may be mixed with the carrier material, especially dried vegetables, cereals, vegetable fibers, extruded and optionally expanded additives or granulated additives. In this context, the invention provides in particular for the density, texture and/or taste of the food product to be adjusted by means of the additive.

In addition, fat may be added to the heat-treated carrier material.

In a further embodiment, the invention provides for individual food products to be formed by compacting, pressing or press moulding. The food products can be formed with cavities which are filled with a prebiotic substance and/or probiotic micro-organisms. It can be provided for the food products to be co-extruded with the substances or micro-organisms mentioned, and these substances can be blended in a suitable carrier substance which facilitates co-extrusion.

The object of the invention is also achieved by an apparatus for heat treating and drying a water-containing carrier material, with a turboreactor comprising a cylindrical reaction chamber with a substantially horizontal longitudinal axis and with a rotor equipped with blades and rotatable about its longitudinal axis provided in the reaction chamber, and having, connected to a steam inlet and a steam outlet of the reaction chamber, a flow path for a steam atmosphere including a condenser.

In this context, it is contemplated that a heat exchanger can be disposed in the flow path downstream of the condenser and/or that a fan is disposed in the flow path and/or that a dust collector, especially a cyclone, is disposed in the flow path.

### BRIEF DESCRIPTION OF THE DRAWINGS

The invention will now be described with reference to a number of embodiments, reference being made to a drawing in which:

FIG. 1 is a schematic diagram to illustrate the method of the invention according to a first embodiment, and

FIG. 2 is a longitudinal section of a turboreactor which is known per se, of the kind used in the method of the invention.

### DETAILED DESCRIPTION OF THE INVENTION

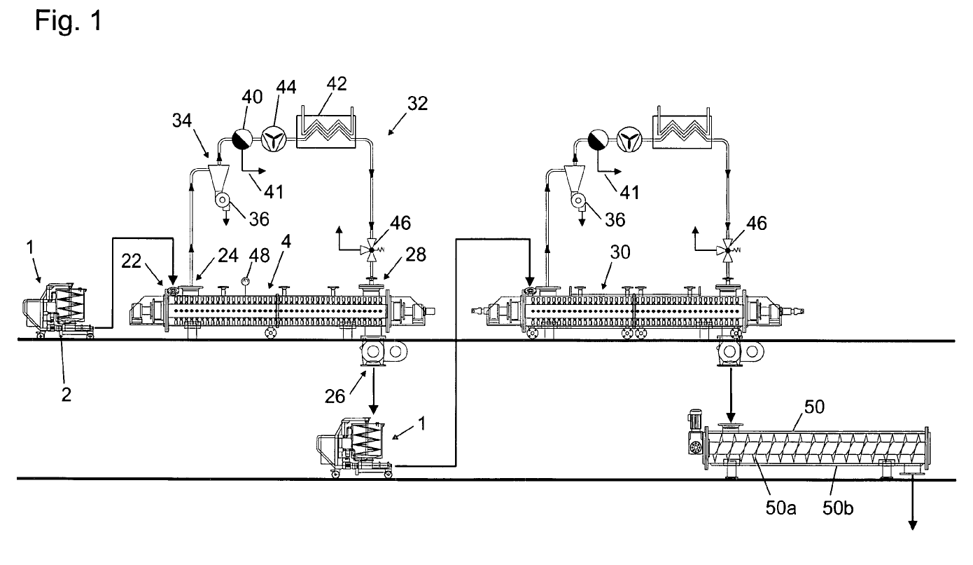

FIG. 1 shows a schematic diagram of a process in accordance with the invention by referring to the apparatus components used. First of all, a carrier material suitable for pumping is produced, which consists virtually exclusively of protein, water and optionally fat. The protein portion of the carrier material can consist of meat, fish, other animal protein or also of protein produced by bacteria or micro-organisms. The proportion of water in the carrier material (total water content, free and bound water) is less than 70% as a rule. The carrier material may contain antioxidants in addition.

A delivery means with a pump 1 transports the carrier material via a metering station with a throughput measuring device 2 to a turboreactor 4, which is known per se, from U.S. Pat. No. 3,527,606 for example. In the turboreactor 4, the carrier material is centrifuged against the inner wall of the turboreactor and forms a thin, highly dynamic, turbulent fluid or partially fluid layer, whose dwell time in the turboreactor is adjusted to about three minutes at about 90° C. Pasteurization or sterilization and at the same time drying takes place in the turboreactor, so that the heat-treated carrier material still has a total water content of about 40% at the outlet from the turboreactor 4.

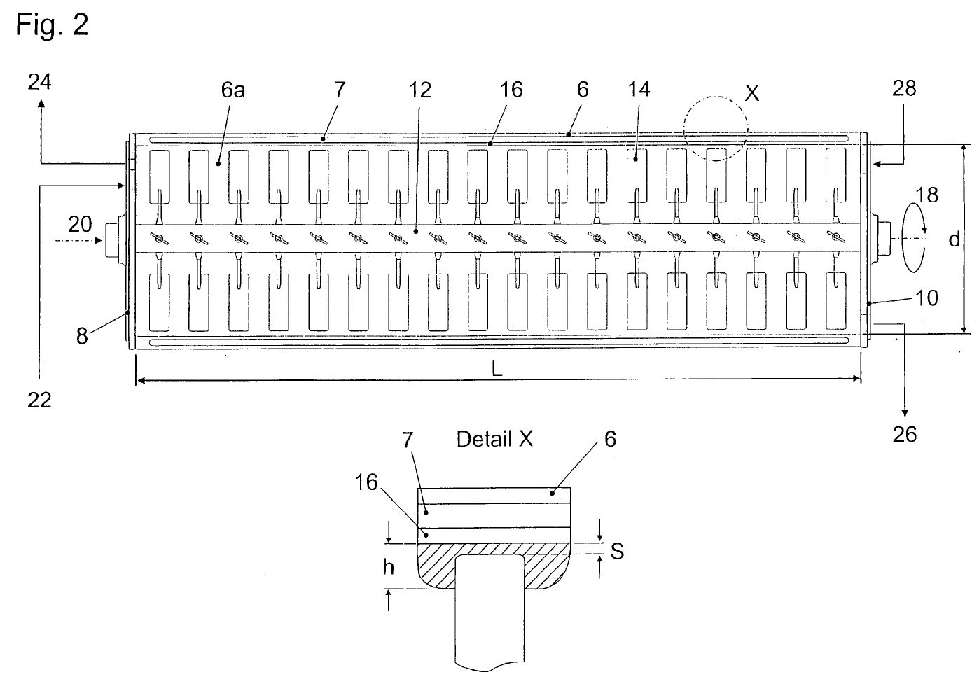

In order to explain the turboreactor 4, reference should be made to FIG. 2. The turboreactor essentially consists of a cylindrical, double-walled housing 6, which forms a heating or cooling jacket 7. Inside the housing 6 is formed a reaction chamber 6a, in which a rotor 12 capable of rotation is mounted on end walls 8, 10, which is provided with a plurality of blades 14 disposed to project radially from the rotor 12. The blades end at a radial distance s, e.g. 5 mm, from an inner wall 16 of the housing 6 and are adjusted, taking into account the direction of rotation (arrow 18) of the rotor, such that they generate a conveying effect in a predetermined direction, in the direction of the end wall 10 in the present case.

The double jacket 7 of the housing 6 can be subdivided in an axial direction (longitudinal axis 20) into a number of chambers separated from one another in order to make different levels of heating or cooling possible from one section to the next.

The turboreactor 4 is normally arranged such that its longitudinal axis 20 is horizontal, though it may also be arranged on a slight incline towards the outlet in order to support the flow of material within the turboreactor by the effect of gravity.

A product delivery point 22 and a steam outlet 24 are disposed in the region of the first end wall 8, while a product removal point 26 and a steam inlet 28 are disposed in the region of the second end wall 10.

With a length L of about 3 m and an internal diameter d of about 35 cm, the turboreactor 4 can be operated at a speed of 750 revolutions per minute, for example. The turboreactor can be fed continuously with a flow of material of, for example, 80 kg/h carrier material, with the temperature of the double jacket of the housing being maintained at 125° C. in order to achieve a product temperature of about 90° C.

Because of the high speed of rotation, the carrier material is centrifuged against the inner wall 16 in a highly dynamic, turbulent layer with an average thickness h of a few millimeters, e.g. 10 mm, in the course of which there is an intensive transfer of heat in the turbulent layer of material from or to the inner wall 16, and there is intensive mixing.

While the carrier material is being fed through the turboreactor, an atmosphere of superheated steam is generated inside the reaction chamber 6a. In the context of the invention, this means that the atmosphere contained in the reaction chamber is at a temperature of between 100° C. and 180° C. and that it consists of a mixture of water vapor and air, with an oxygen ratio of no more than 10% by volume, which corresponds to a maximum of about 50% of the oxygen partial pressure prevailing in the ambient air. The oxygen ratio is preferably even less, going as far as an infinitesimal oxygen content, with the steam atmosphere then in effect consisting exclusively of “dry” or superheated water vapor.

The advantage of the low oxygen content is firstly the special product quality (taste, storage quality) and secondly the fact that any risk of ignition or explosion in operation is removed, which may otherwise result when drying with air, because of the high temperatures and the volatile components present, such as fats, oils etc.

The steam atmosphere inside the reaction chamber is preferably characterized by a temperature gap relative to the respective condensation point, i.e. the temperature of the superheated steam, or of the steam/air mixture is higher than the temperature at which the steam is saturated and condensation occurs. As a result, the steam atmosphere can absorb moisture from the carrier material and dry the latter.

As far as the apparatus is concerned, it is preferably provided, for the generation of the steam atmosphere, that the relatively moist or even wet steam atmosphere (containing water droplets) withdrawn from the reaction chamber via the steam outlet 24 is directed via a flow path generally indicated by 32. The steam atmosphere passes through a dust collector 34 (cyclone) with a dust remover 36 and then passes via a fan 44 first into a condenser 40 with a condensate outlet 41. The steam emerging from the condenser, which is substantially in a saturated state, or the moist air is raised in a heat exchanger 42 to a desired temperature above 100° C., e.g. 130 or 150° C., which corresponds to a reduction in the relative humidity, or a certain gap relative to the saturation state (100° C. at atmospheric pressure, provided it is pure steam).

The fan 44 transports the superheated steam, or the superheated steam/air mixture, via the steam inlet 28 in counterflow relative to the product stream, into the reaction chamber 6a.

In the course of travelling from the steam inlet 28 to the steam outlet 24, the superheated steam atmosphere comes into contact with the carrier material present in the reaction chamber 6a, absorbs moisture from it and cools down as a result.

Alternatively, instead of feeding in superheated steam from outside, it could be provided that the superheated steam is generated directly inside the reaction chamber 6a by contacting the moist carrier material with a heated, sufficiently hot inner wall 16. In addition or as an alternative to heating the inner wall, thermal energy can be supplied to the reaction chamber by microwave input, electric heating elements or heat exchangers.

In both variants of the process, it is possible, in accordance with the invention, to ensure that the oxygen content in the reaction chamber 6a is substantially lower than in the ambient air, e.g. less than 10% by volume, 5% by volume, 3% by volume or 1% by volume. When operating with pure water vapor, an oxygen content or oxygen partial pressure of almost zero can be achieved. In order to monitor the oxygen content, an oxygen sensor 48 can be provided in the reaction chamber, e.g. in the vicinity of the steam inlet or steam outlet. An oxygen sensor in the course of the flow path 32, e.g. upstream or downstream of the condenser or upstream or downstream of the heat exchanger is likewise possible.

Although the turboreactors 4, 30 are preferably operated at ambient pressure, or atmospheric pressure, it is also possible, provided the turboreactors are sealed appropriately, to operate at overpressure, e.g. at 1.5 bar, 2 bar or more. Conversely, it is likewise possible to operate with a partial vacuum, e.g. at 0.9 bar, 0.8 bar, 0.5 bar or even less. A safety valve 46 protects the system against inadmissible pressures.

FIG. 1 also shows that the heat-treated and dried carrier material can be fed to a turboreactor 30 downstream for final drying, which may have an identical structure to the turboreactor 4, and which the carrier material leaves in the form of, for example, substantially dried meat or protein, with a total water content of less than 10%, for example. The carrier material, which may still be sticky because of its fat content, can be cooled in a cooler 50 and now has a particulate, pourable consistency, in which it can be poured into storage containers for the appropriate types (beef, lamb, fish, . . . ).

The cooler 50 may be designed as a disk cooler, as shown in FIG. 1, and may comprise a barrel extruder 50a, which is jacketed and water-cooled, and an extruder drum 50b, which is likewise jacketed and water-cooled. The dried product is cooled gently without coming into contact with air or oxygen and is conveyed at the same time to mixing and metering stations downstream.

One or more other storage container(s) contain(s) prebiotic substances, which in the present connection should be understood to mean substances that have a favorable effect on the life and/or growth of the probiotic micro-organisms, e.g. substances that can be absorbed or processed in some other way by the probiotic micro-organisms, so that their numbers increase and/or their vitality is improved, and also further additives such as vegetable fibers.

In a mixer, the carrier material of one or more desired kinds may be mixed with other substances via a metering station, namely first with probiotic micro-organisms which are added in doses via a mixer and a pump. The probiotic micro-organisms may be encapsulated in a suitable matrix and optionally premixed with the addition of oil before being added to the mixer.

An additional additive may be a binder, which is preferably a starch-free binder. Fat can also be added.

A mould press presses the food product into a desired final shape, e.g. into small, compact bite-sized food pellets. It may be either a foodstuff for human consumption, or equally an animal feed, e.g. for pets or breeding animals. Fish feed may also be manufactured in this way, and in this case an increased fat content is often desired, which can be achieved by adding appropriate quantities.

### LIST OF REFERENCE NUMERALS

1 Delivery means
2 Throughput measuring device

### 4 Turboreactor

### 6 Housing

6a Reaction chamber
7 Heating jacket
8 First end wall
10 Second end wall

### 12 Rotor

### 14 Blade

16 Inner wall (of 6)

### 18 Arrow

20 Longitudinal axis
14 Product delivery point
24 Steam outlet
26 Product removal point
28 Steam inlet

### 30 Turboreactor

32 Flow path
34 Dust collector
36 Dust removal

### 40 Condenser

41 Condensate outlet
42 Heat exchanger

### 44 Fan

46 Safety valve
48 Oxygen sensor
50 Disk cooler
50a Barrel extruder
50b Extruder drum

### s Gap

### L Length (of 6)

d Internal diameter (of 6)
h Layer thickness

1. A method of manufacturing a food product, comprising the steps of:
delivering a water-containing carrier material to a turboreactor, which has a cylindrical reaction chamber with a substantially horizontal longitudinal axis and with a rotor equipped with blades and rotatable about said longitudinal axis of the reaction chamber;
rotating said rotor at a speed sufficient to centrifuge the carrier material against an inner wall of the reaction chamber and to form a dynamic, turbulent layer at said inner wall;
heat treating and drying said carrier material in said reaction chamber;
advancing said carrier material in the direction of an outlet of said turboreactor and withdrawing the heat-treated and dried carrier material as a food product from the outlet;
wherein an atmosphere of superheated steam with an oxygen content of less than 10% by volume is generated in said reaction chamber.

2. The method as claimed in claim 1, wherein individual food products are formed from the heat-treated and dried carrier material.

3. The method as claimed in claim 1, wherein the heat-treated and dried carrier material is provided with a prebiotic substance and/or probiotic micro-organisms.

4. The method as claimed in claim 3, wherein the carrier material is sprayed or coated with said prebiotic substance and/or said probiotic micro-organisms.

5. The method as claimed in claim 3, wherein the carrier material is mixed or coated with the probiotic micro-organisms in an encapsulated form.

6. The method as claimed in claim 1, wherein the carrier material is protein-containing.

7. The method as claimed in claim 1, wherein fibers or particles present in the carrier material are comminuted, before delivery to the reaction chamber, to a length of less than 5 mm or less than 3 mm.

8. The method as claimed in claim 1, wherein the inner wall of the turboreactor is heated to a temperature in the range of between 50° C. and 150° C.

9. The method as claimed in claim 1, wherein the inner wall of the turboreactor is heated up in sections to different temperatures rising or falling steadily in a longitudinal direction.

10. The method as claimed in claim 1, wherein the method is carried out continuously.

11. The method as claimed in claim 1, wherein during the heat treatment of the carrier material, an inert gas, such as CO₂ or N₂, is passed through the reaction chamber.

12. The method as claimed in claim 1, wherein the carrier material is further dried after leaving the turboreactor in a second turboreactor.

13. The method as claimed in claim 1, wherein the superheated steam is delivered in counterflow to the carrier material.

14. An apparatus for heat treating and drying a water-containing carrier material, comprising:
a turboreactor comprising a cylindrical reaction chamber with a substantially horizontal longitudinal axis and a rotor equipped with blades and rotatable about the longitudinal axis of the reaction chamber; and,
a flow path for a steam atmosphere including a condenser connected to a steam inlet and a steam outlet of the reaction chamber.

15. The apparatus as claimed in claim 14, wherein a heat exchanger is disposed in the flow path downstream of the condenser.

16. The apparatus as claimed in claim 14, wherein a fan is disposed in the flow path.

17. The apparatus as claimed in claim 14, wherein a dust collector is disposed in the flow path.

18. The apparatus as claimed in claim 14, wherein a cooler is downstream of the turboreactor.

19. The apparatus as claimed in claim 18, wherein the cooler is designed as a disk cooler.

20. The apparatus as claimed in claim 17, wherein the duct collector is a cyclone.
